(19) United States
(12) Patent Application Publication
(10) Pub. No.: US 2006/0248548 A1
(43) Pub. Date: Nov. 2, 2006

(54) Optical card drive with adaptive receiving tray and focusing adaptor

(75) Inventors: Francis K. King, San Jose, CA (US); Jeffrey Liu, San Jose, CA (US)

Correspondence Address: Bo-In Lin, 13445 Mandoli Drive, Los Altos Hills, CA, 94022, US

(73) Assignee: DCARD, INC.

(21) Appl. No.: 11/118,222

(22) Filed: Apr. 28, 2005

(51) Int. Cl. G11B 33/02; G11B 7/00; G11B 17/03; G11B 17/04

(52) U.S. Cl. 720/601

(57) ABSTRACT

An optical card or disc drive having a card or disc adaptive receiving carrying tray. A compound pivot mechanism engages a spindle hub with a card or disc inserted and carried on the tray. The spindle and hub is supported by a base chassis, which pivots with respect to a main frame. A sub-chassis is pivot connected with the mainframe and elastically coupled with the base chassis. A cam member on the main frame engages the sub-chassis to pivot the sub-chassis coincident with the tray being level positioned or lowered relative to card spindle hub. The sub-chassis in turn pivots the base chassis to engage or disengage the disc with the spindle hub. The movement of the tray also activates a motor and roller combination to receive or eject the card into or from the tray. The tray accommodates card or discs and comprises mechanisms for securing the card or disc while the card disc is retracted into and ejected from the main frame. A card guide member acts to reposition the card into tray slot after the card disengaging from the spinning spindle hub for ejection out of mainframe. A focusing adapter member works to meet the optical pick unit focusing distance requirement for difference thickness of optical card or disc.

### BACKGROUND OF THE INVENTION

1. Field of the Invention

This invention relates generally to systems and method for optical card drives. More particularly, this invention is related to a method and apparatus for loading optical card/disc that has information-recording material thereon along a path to a reference location about which the card/disc is held and rotated, whereby the recording material can be read and/or written.

2. Description of the Prior Art

The technologies as that commonly implemented in conventional optical disc drive for reading and writing data to disc storage medium are typically designed to handle rotating disk having a circular shape. Such conventional disc drives cannot be conveniently applied for carrying out data access functions for data stored in a data storage card compatible with regular credit card having a rectangular shape. Furthermore, regular optical disc drive has a thickness of 1.2 mm while a credit card has a smaller thickness of 0.76 mm. The difference in thickness further complicate the data access functions when a regular optical drive as now available is implemented to carry out data access functions for both a card shape data card and a circular disc.

Several systems and configurations are described in U.S. Pat. Nos. 4,507,768, 4,592,039 and 6,804,184 for conventional optical disc such as CDROM, CDR, and DVD in either top or front loading. These systems are applicable for disc drives employed for circular discs only. U.S. Pat. No. 4,800,551 disclosed a method for loading and unloading optical rectangular card. The device serves satisfactorily. However, the system configuration is quite complicated in construction and operation and would not be practical for cost effective implementations.

U.S. Pat. No. 6,865,141 describes method to switch optical focus (focus jump) to different recording layers of an optical media such as DVD. Such or similar method applies to recording layers separated by distance in the micrometers range. When the layer location is changed in the mini-meter range, such or similar methods cannot be used.

These patented inventions however do not provide relevant or effective solutions to enable an optical drive to process the data access functions to both a credit card shaped data card and a regular circular data disc. Therefore, a need still exists in the art to provide improved and new configuration and of optical drive and data access process to overcome such limitations.

### SUMMARY OF THE PRESENT INVENTION

Therefore, an object of this invention is to provide a system and method to receive and engage a rectangular data card or a circular data disc of different thicknesses to conveniently carry out data access functions.

The present invention further provides an improved method of an apparatus for transferring a generally rectangular card or circular disc, having binary coded information stored on concentric and/or spiral tracks and or segmented circular and or spiral tracks, to a rotational reference location where the card/disc can be rotated thereabout.

Included in the apparatus is a housing assembly, which may house a card/disc reader and/or writer device. Methods provide for transferring the card/disc from a slot opening in housing to a receiving tray and to the spindle motor hub rotational reference axis. Means are provided for positioning the card at the spindle motor hub reference axis and for allowing rotation of the card/disc about the reference axis. The data tracks can be read and/or written.

In illustrated embodiments, the cam mechanism system of reader and/or writer device is operable for engaging, disengaging, and rotating the card/disc about the rotational reference axis. Provision is made for means for holding and positioning the card after the stop of rotation and return to the seating of tray at proper orientation with a stop guide.

In another illustrated embodiment, the sensing the presence of a card for ejection or receiving and algorithm to orient the card to a proper seating for ejection out of the housing.

In another illustrated embodiments, the optical focus adapter used to compensate relative drastic change of the thickness of card/disc that can prevent data read and/or write to data tracks.

Among other objects of this invention are, therefore, the provision of a method of and apparatus, which can easily be adapted to commercially available compact disc players.

Briefly, in a preferred embodiment, the present invention discloses an optical drive for accessing data stored in an optical medium layer on a data card. The optical drive includes a receiving tray supported on a chassis for pivoting on a cam member for disposing the data card in two different vertical positions in the optical drive for an insertion/rejection operation at a first vertical position and for accessing data at a second vertical position. In a preferred embodiment, the receiving tray further includes a card placement seat for receiving and placing the data card having a rectangular shape. In another preferred embodiment, the receiving tray further includes a disc placement seat for receiving and placing the data card having circular-disc shape. In another preferred embodiment, the cam member further includes a post for driving the receiving tray along a horizontal direction for receiving the data card in for accessing data on the data card and for pushing the data card out after completing a data access operation. In another preferred embodiment, the optical drive further includes a spindle motor supported on the chassis for engaging and rotating the data card through an opening in the receiving tray. In another preferred embodiment, the optical drive further includes an optical pickup head supported on the chassis for accessing data on the data card through an opening in the receiving tray. In another preferred embodiment, the optical drive further includes an accessing motor supported on the chassis for horizontally moving the optical pickup head for accessing data in different tracks on the data card through an opening in the receiving tray. In another preferred embodiment, the optical drive further includes a roller fixture actuated by a spring for pulling the data card into the receiving tray and pushes the data card out from the optical drive. In another preferred embodiment, the optical drive further includes a card stop for stopping a rotation movement of the data card of a non-circular shape and for restoring the data card in an original insertion orientation whereby the data card is ready for ejecting out from the optical drive. In another preferred embodiment, the optical drive further includes a focus adapter attached to an optical pickup head for compensating a thickness difference of the data card to maintain focus on the optical medium layer. In another preferred embodiment, the focus adapter includes a fixed lens attached to the pickup head.

In a preferred embodiment, this invention further discloses a method for accessing data stored in an optical medium layer on a data card by employing an optical drive. The method further includes a step of attaching a focus adapter to an optical pickup head to enable the optical drive to access data store in a data card of different thickness. In a preferred embodiment, the step further includes a step of attaching a focus adapter of 0.4 mm thick to an optical pickup head in the optical drive for receiving the data card of 0.76 mm in a commercially available CD or DVD optical drive.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

The above objects and advantages of the present invention will become more apparent with reference to the attached drawings in which:

FIG. 1 is a perspective view showing an optical card/disc drive according to the present invention. The cutout shows the receiving tray, spindle motor and optical pickup unit only.

FIG. 2 is a view showing a inserted card, the receiving tray and pivot structure that carries the receiving tray cam mechanism, card sensor, card stop, spindle motor, accessing motor, and optical pickup unit.

FIG. 3 shows the receiving tray and the cam for push pull of the tray.

FIG. 4 is a view showing a pivot structure of the base chassis in the optical card/disc drive, the receiving tray at up position for receiving or ejecting card/disc.

FIG. 5 is a view showing a pivot structure of the base chassis in the optical card/disc drive, the receiving tray at down that allows the card/disc to rotate for data accessing.

FIG. 6 is a sectional view showing the card/disc push pull roller arrangement.

FIG. 7 is a side view showing the tray and card/disc roller.

FIG. 8 is section view showing the card/disk roller feeder at unloaded position.

FIG. 9 is section view showing the card/disk roller feeder at loaded position.

FIG. 10 shows the spindle motor, optical unit, and accessing motor on a pivoted chassis engaged to a lifting cam.

FIG. 11 shows the end view of a lifting cam member.

FIG. 12 shows a card stop guide at engaged position.

FIG. 13 shows a card stop guide at disengaged position.

FIGS. 14A, 14B and 14C show optical pickup units and their focusing arrangements.

FIG. 15 shows a fixed version of focusing adaptor attached to optical pickup unit.

FIG. 16 shows a pivoting version of focusing adaptor attached to optical pickup unit.

FIG. 17 shows an algorithm for card/disc insertion and ejection process.

FIG. 18 shows a modified top loading tray for a drop in card.

FIG. 19 shows a modified top loading tray for a drop in card that is off center.

### DETAILED DESCRIPTION OF THE PREFERRED EMBODIMENT

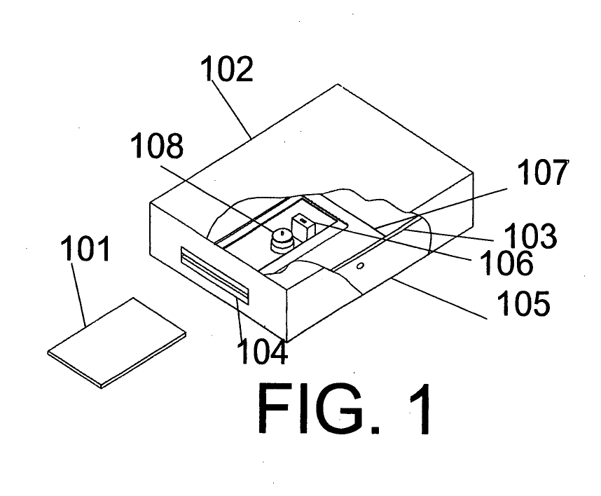

FIG. 1 shows a card 101 or alternately a disk for inserting into an optical drive 102 through a front slot opening 104. The optical drive 102 receives the card 101 (or alternately a circular disk) to carry out different data accessing functions, e.g., either read data from or write data to the card 101. The cutout portion of the drive 102 shows a spindle motor 108 with built-in hub for rotating and moving the data card 101. The optical drive 102 further includes an optical pickup unit 106 that support an optical head to carry out the read and write data access functions. The optical drive 102 further includes a receiving tray 107 mounted to drive frame 105 to receive the card 101 or disc wherein the operations and functions of the receiving tray 107 will be further described below.

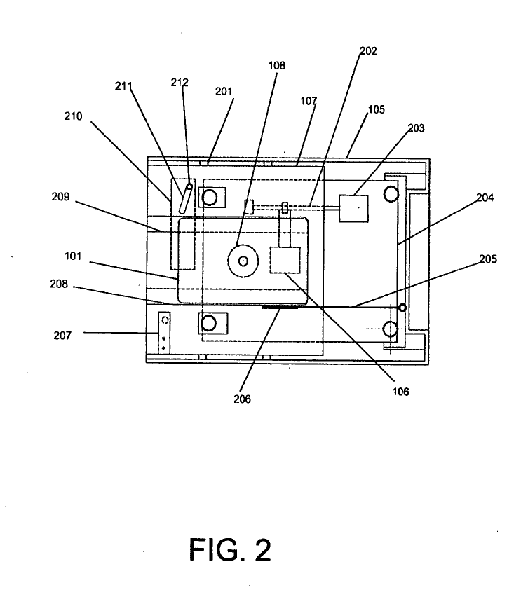

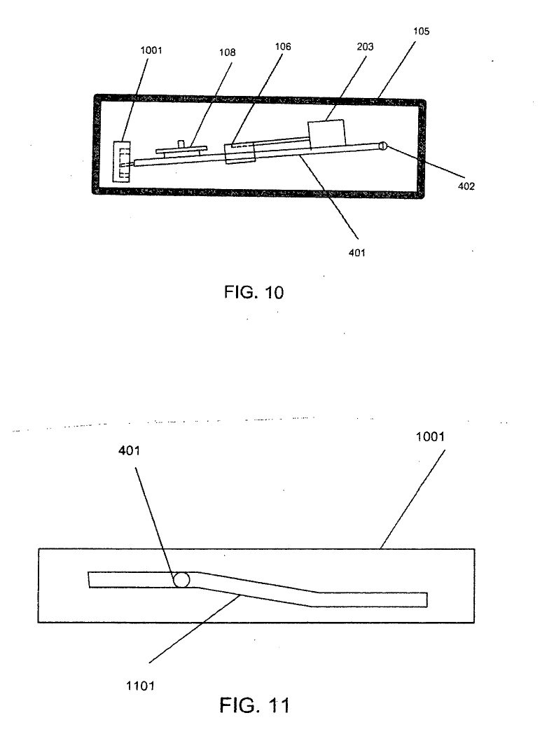

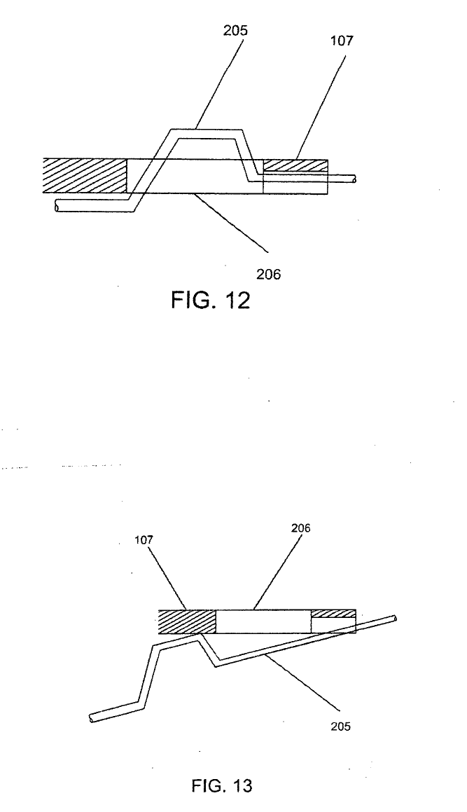

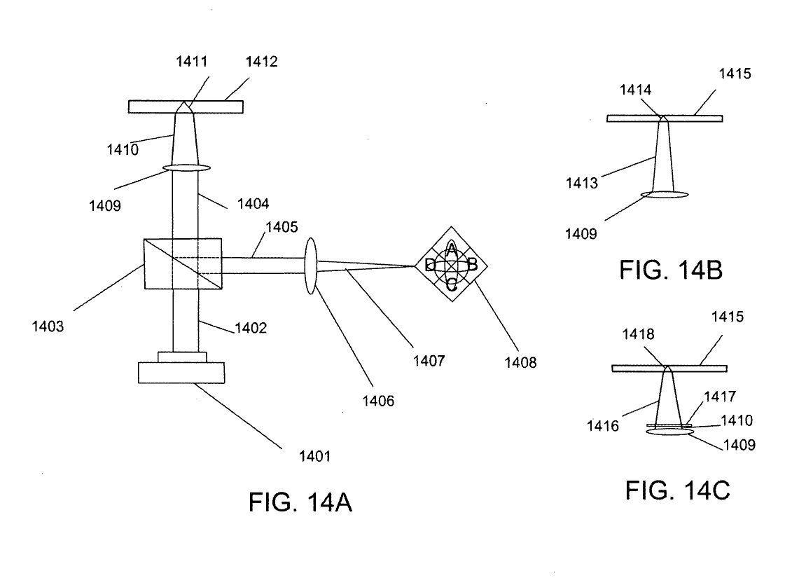

FIGS. 2 to 5 show the motion and control mechanisms of tray 107. FIGS. 6 to 9 illustrate the card/disc push pull mechanics. FIGS. 10 and 11 illustrate the operations and functions of the cam 1001 and chassis 401. FIGS. 12 and 13 show the functions of the card stop 205. FIGS. 14 to 16 illustrate the functions performed by a focus adapter 1417.

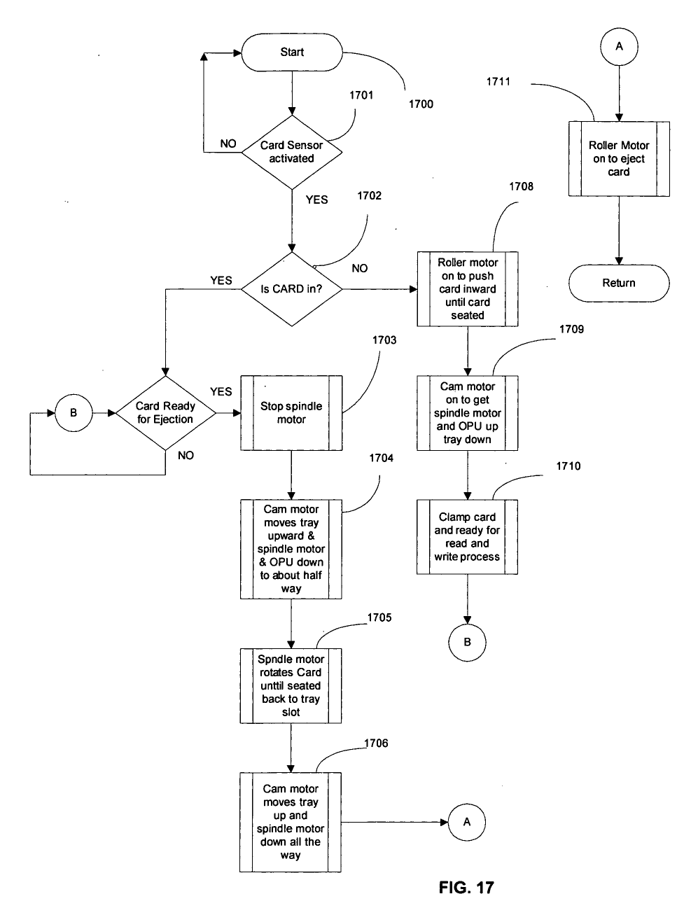

Referring to FIG. 2, the receiving tray 107 is mounted to the drive frame 105 through four linkages 201. The data card 101 when inserted into the optical drive 102 is seating on the receiving tray 107. The spindle motor 108, the optical pickup unit 106, and the accessing motor 203 with a lead screw 202 are below the receiving tray 107. These items are attached to a pivoted chassis 204. A cam member 210 drives the tray 107 and chassis 204. A post 212 on the cam 210 can drive the tray back and forth in the slot 211. When the post 212 moves side-to-side in the slot 211, the movement causes the tray 107 to move. An opening 209 in the tray 107 allows the spindle motor 108 to engage the card or disc for rotational motion. The accessing motor 203 with lead screw member 202 are employed to push and pull the optical pickup unit 106 to access different data tacks on the data card 101 for reading and writing. A data-medium placement seat 208 in the receiving tray disposed on both sides of the opening 209 is provided as a seat receiving a card or a disc during insertion or ejection of the card or disc. The placement seat 208 can be rectangular in shape for a rectangular card or circular in shape for disc. A card/disc sensor 207 is applied to detect a card/disc under the sensor to indicate card/disc presence and starts the card/disc push or pull sequence of processing step as will be further described in FIG. 17 below. The card stop 206 is located next to and protrudes to the edge of the placement seat 208 in the tray. An extension 205 of the card stop 206 is fixed to the frame 105 and therefore cannot move in either length direction or along other side way directions. The card stop 205 attached to the extension 205 can only move one end at tray slot 206 up and down relative to the tray 107. When the card stop 206 along with the extension 205 is protruding up from the tray slot 206, the card stop 206 is provided to prevent the card 101 to rotating across over the stop 205. When the card stop 206 attached to the extension is moved under the tray 107, the card 101 card is allowed to rotate freely. The card stop 206 is necessary only for the card shaped media and is not needed for disc shaped media because a card 101 must be oriented properly to pass through the drive slot 104 as that showed in FIG. 1.

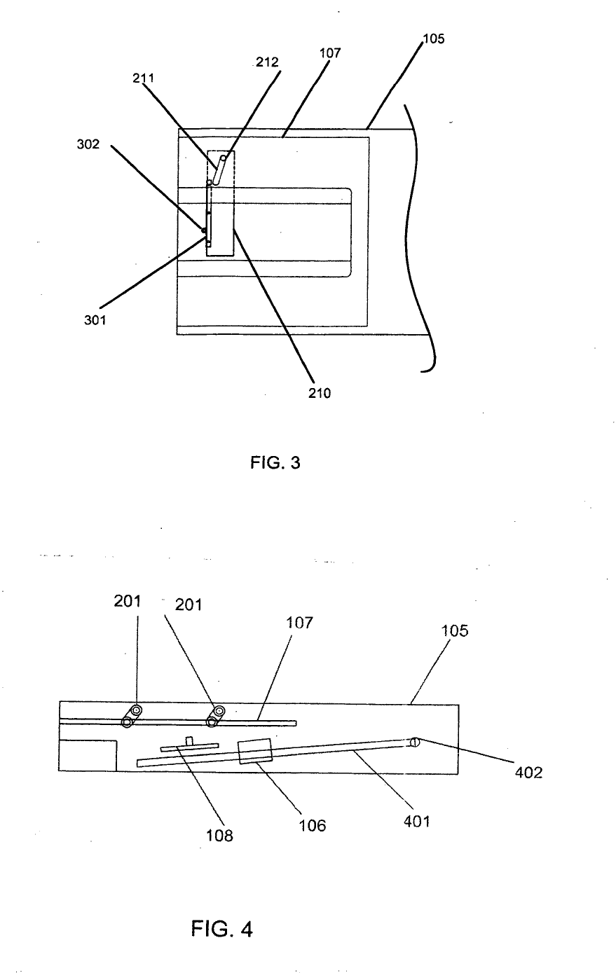

FIG. 3 shows a rack 301 and a pinion 302 arranged as part of the cam member 210. The pinion 302 is driven by a motor through gear train or belt and pulley arrangement not showing in the Figure. The rack 301 and pinion 302 are driven by a motor not shown that moves cam 210 and post 212 side to side. The slot 211 of the tray 107 combines with the post 212 drive the tray 107 to move back and forth perpendicular to the side motion.

FIG. 4 is a side cross sectional view that shows the tray 107 is moved toward front. Since the linkages 201 tie the tray 107 to the frame 105, the tray 107 actually move forward and up as a member of a four bar linkage mechanism. With the receiving tray 107 in a forward position as shown, a card/disc 101 can be inserted to or ejected from the tray 107 through the slot 104 as FIG. 1. Spindle motor 108, optical pickup unit 106 and other drive members not shown are mounted to a chassis 401 that can pivot about a hinge 401 tied to frame 105. When the tray 107 is at forward and up position, the chassis 401 is kept at a lower pivoted position thus the chassis and the devices supported thereon are away from and have no interferences with the motions of the card/disc supported on the tray 107 now pivoted to an elevated position away from the chassis 401. A cam member controls the pivot motion that is further described in FIG. 10 below.

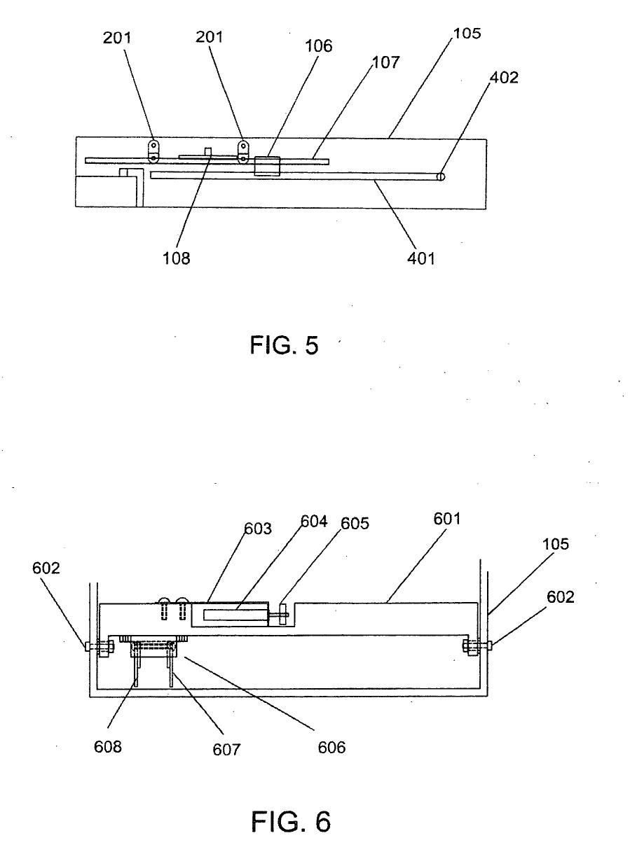

In contrast to FIG. 4, FIG. 5 shows the receiving tray 107 disposed at lower position as the tray 107 is moved away from the front end of the optical drive. The chassis 401 is pivoted to an elevated position through a pivot hinge 402. At the elevated position, the spindle motor 108 is applied to engage the card/disc 101 and the spindle motor 108 is employed to rotate the card 101 as it has room to freely rotate around a rotating axis. The card/disc 101 is properly clamped to the spindle motor 108. At this arrangement, optical pickup unit 106 can access data tracks of a card/disc with proper control circuits (not shown).

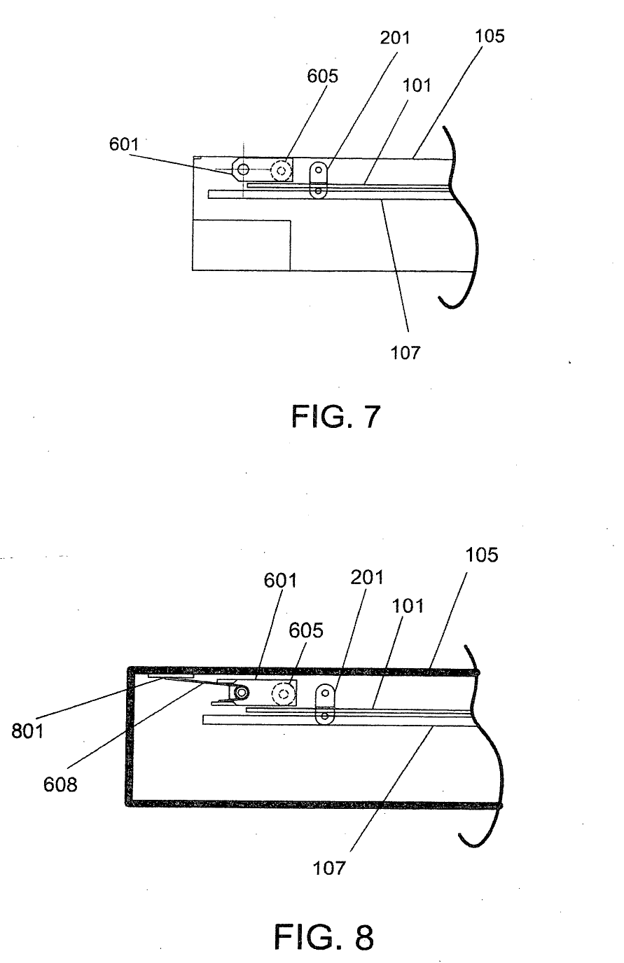

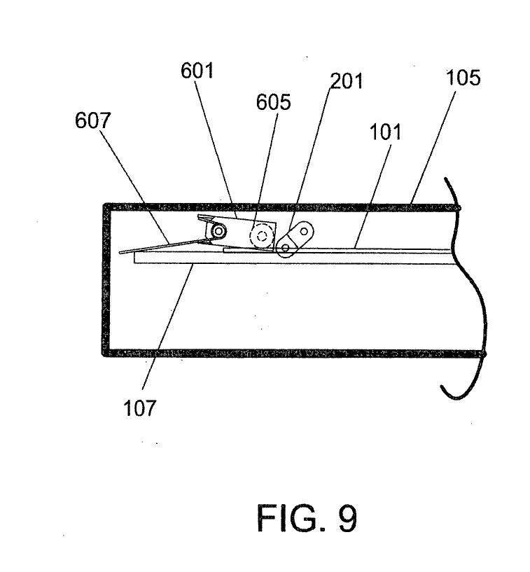

FIG. 6 illustrates a roller fixture 601 that mounted to the frame 105 through a hinge 602. The fixture can rotate about the hinge 602. A motor 604 is mounted to fixture 601 by a bracket 603. A pressure roller 605 is attached to motor 604. The pressure roller 605 serves as push pull mechanism when a card/disc is pressed between the roller 605 and the tray 107. The card/disc 101 moves along the surface of the tray 107 by the roller 605. A spring bracket 606 as part of the roller fixture 601 further includes an unload spring 608 and a download spring 607. FIG. 7 is a side cross sectional view of the relative positions of the roller fixture 601 and the tray 107 when the tray 107 is disposed at a lower position. The linkage 201 mounted the tray 107 to the frame 105 is shown at a lower elevation position. A card/disc 101 is shown above the tray 107. The roller fixture 601 is at upper position with the roller 605 away from and not in contact with the card/disc 101. The tray 107 and chassis are at data access position. FIG. 8 is similar to FIG. 7 showing the unload spring 608 is acting by the spring stop 801 at frame 105. The leg of spring 608 forced fixture 601 to rotate about the hinge center and lifting the roller 605 off the card/disc 101. In contrast to FIG. 8, FIG. 9 shows the tray 107 and linkage 201 are at upper and forward position and the card/disc 101 is placed in the tray 107. The tray 107 pushes the leg of loading spring 607 and forcing the fixture 601 rotating downward that in turn forcing the roller 605 squeeze the card/disc between roller 605 and tray 101. Depending the system requirement, the roller 605 spins to either push toward or pull inward the card/disc through the slot 108 in FIG. 1 along the surface of tray 107.

FIG. 10 shows a chassis 401 pivoted at 402 against the frame 105. The chassis 401 is mounted with spindle motor 108, optical pick unit 106, accessing motor 203 and other drive components not shown. The chassis 401 is driven by cam 1001 that is part of cam member 201 shown in FIG. 2. The cam 1001 moves the chassis 401 to swing around pivot point 402. When chassis 401 is swing up, the spindle motor 108 engages the card 101 for data accessing by the optical pickup unit 106. When the chassis is swing down, the spindle motor 108 is disengaged from the card/disc 101 and allows the tray 107 to receive or eject the card/disc. FIG. 11 shows the guide slot 1101 in the cam member 1001. A pin 404 is part of the chassis 401 the can move in the slot. When the cam 1001 moves to right side of the slot 1101 as shown, the chassis 401 is swung upward. When the cam 1001 moves to the left side of the slot 1101, the chassis 401 is swung down.

FIG. 12 shows a card stop 205 protruding from the tray slot 206 in the tray 107 when the tray 107 is positioned at an up and forward position. With the stop 205 up, a card 101 is stopped from a rotation movement when the edge of card 101 reaches the stop 205. FIG. 13 shows the stop 205 at its retracted position. When the tray 107 is pulled down and moved toward the anchor side of the stop 205, the stop 205 does not move with the tray 107 and the end of the stop 205 is only allowed to extend out from the tray slot 206 and sit against the bottom of the tray 101. A card/disc 101 can rotates freely above the tray 107. When the optical drive stops the rotation of the spindle motor 108 and prepares to eject a disc shaped media, the spindle motor 108 is disengaged from the disc and the disc drops to the circular shaped seat 208. The tray 107 moves up and forward while the chassis 401 and the roller fixture 608 move down. The roller 605 is activated to push the disc out of the slot 108. For a card shaped media, the car stop 205 is required to orient the card 101 such that the card 101 can be proper placed into the rectangular-shaped placement seat 208. In this preferred embodiment, the operation of the optical drive begins a control signal that stops the spindle motor 108 then moves the receiving tray 107 about half way to a proper level position. The operation processes continue with a swing of the chassis 401 down to a level that is not all the way down as the receiving tray 107 is not all the way up yet. At this point, part of the stop 205 is protruding from the slot 206. Furthermore, the spindle motor still clamps onto the card 101. The card is moving in a downward direction toward the receiving tray 107. Under the circumstances when the card 101 moves down to be on top of the stop 205, the card 101 just pushes the stop 205 back into the slot 206. Then the card 101 still has free space to rotate and will rotate with the spindle motor 108. The card 101 then spins slowly and intermittently with marginal torque. As the card 101 swings by the stop 205 and is no longer on top of the stop 205, the stop 205 pops out from the slot 206. Then the card 101 is blocked by the stop 205 at next revolution and seated into seating 208. Any further rotating movement of the card 101 by the spindle motor 108 is prevented by the stop 205. Once the card 101 is seated, the card 101 is disengaged from spindle motor 108. The chassis 401 continues to swing down all the way and move the tray 107 to a card rejection position for roller the 605 to eject the card 101 through the slot 108 shown in FIG. 1.

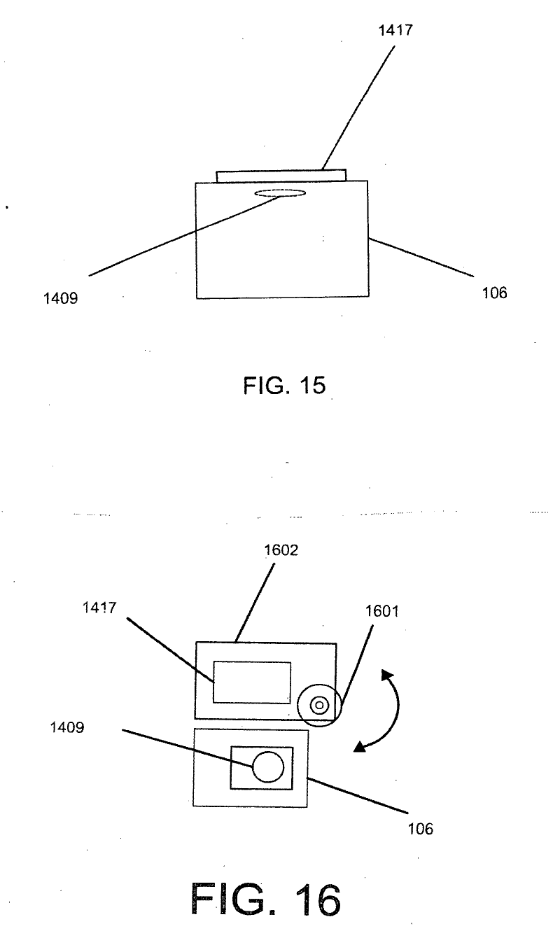

FIGS. 14A, 14B and 14C illustrate the variations of focus length of the optical pickup unit to accommodate changes of the card or disk thickness. As shown in FIG. 14A, a laser source 1401 shines a beam 1402 to pass through a beam splitter 1403 as projecting-through beam 1404. The projecting-through beam 1404 reaches objective lens 1409 and proceeds as beam 1410 to shine upon the optical media 1412. The beam 1410 enters media 1412 as a converging beam 1411 and focus to the target surface 1412. The converged beam 1411 then reflects back from the data storage media 1412 and projected back through objective lens 1409. The reflected beam reaches the beam splitter 1403 and reflects into a reflecting beam 1405. The reflecting beam 1405 is projected from the beam splitter 1403 and passes through another objective lens 1406 to generate a converging beam 1407 to project onto a photo diode 1408. The photo diodes 1408 converts light beam to electrical signals for focusing, tracking and data decoding process. A commercial CDROM, CDR, and CDRW and DVD drive use such or similar method to access data stored in the media 1412 that usually has a thickness of approximately 1.2 mm built with polycarbonate material with light reflection index 1.55. FIGS. 14B and 14C show a data storage media has a thickness of approximately 0.76 mm, e.g., having a same thickness as that of a typical credit card or ID card. FIG. 14B shows the focus beam 1411 as that shown in FIG. 14A is now changed to another converging beam 1414 due to less travel of the beam in media 1415. In order to reach the same target focus size, the distance between media 1415 and objective lens 1409 must be increased such that beam 1413 is smaller than beam 1410. In order to read data from and write data to the media 1415 with different distance as original design as beam 1410, the laser beam power 1413 must be adjusted to a higher value. Even though the data can be written to media 1415 with higher power, the reflected beam from media 1415 back to photo diode matrix 1408 is distorted and cannot be decoded properly. Proper access of data is not achievable. It is impractical is to modify the objective lens 1409 and 1406 in existing optical pickups to compensate the media thickness change. As shown in FIG. 14C, a simpler method is to attach a focusing adapter 1417 that can compensate the media thickness changed as 1415. The beam 1410 as that shown in FIG. 14A is modified by the adapter 1417 to 1416 and 1418. The laser beam read/write power can be maintained as a regular unit, regular optical read, write, encode, and decode applies. The focus adapter 1417 can be a plain, convex, or concave lens as configuration required. A preferred embodiment that employs commercial available optical drives for accessing data stored in CDROM, CDR, CDRW storage media, a focus adapter of 0.4 mm plain lens is implemented to access data stored in media that has a thickness changed from 1.2 to 0.76 mm. FIG. 15 shows a fixed adapted 1417 attached to an optical pickup unit 106 and the objective 1409 stays same. FIG. 16 shows top view of optical pickup unit 106 and objective lens 1409. A focus adapter 1417 is mounted in a frame 1602 and can be swing over the objective lens 1049 by an actuator motor 1601 under system management. Such swinging in and out adapter arrangement can be controlled by dynamically changing command to access data stored in media having different thicknesses, e.g., 1.2 mm or 0.76 mm.

FIG. 17 illustrates an algorithm with processing steps to carry out the functions of receiving and rejecting card. The process starts (step 1700) with a determination of whether a card 101 is detected by the card sensor 207 (step 1701). When a card 101 is detected a determination then made if the card is in the fully inserted position (step 1702). Under the circumstances that the card is not fully inserted yet, the roller motor 605 is actuated to pull in the card (step 1708) and meanwhile, the cam motor is actuated to engage the spindle motor 108 and to position the OPU 106 up and the receiving tray down (step 1709). Once the card 101 is pulled into the placement seat 208, an operation to clamp the card and ready for read or write is carried out (step 1710) and the process continues based on the condition that the card 101 is in a fully inserted. The operation then proceeds with a determination if a rejection of the card 101 required (step 1712). If a card rejection is confirmed, the spindle motor 108 is stopped first (step 1703). The cam motor then moves the try upward and the moves the spindle motor 108 and the OPU 106 down to about a half way down position (step 1704). Then the spindle motor 108 rotates the card 101 until the card is rested in the placement seat 208 in the receiving tray 107 (step 1705) as that shown in FIGS. 12 and 13. Once the card 101 is seated and oriented properly, the receiving tray 107 is moved up all the way and the chassis 401 is moved all the way down (step 1706). Then the roller motor fixture 601 is actuated onto the card 101 to push the card out (step 1711).

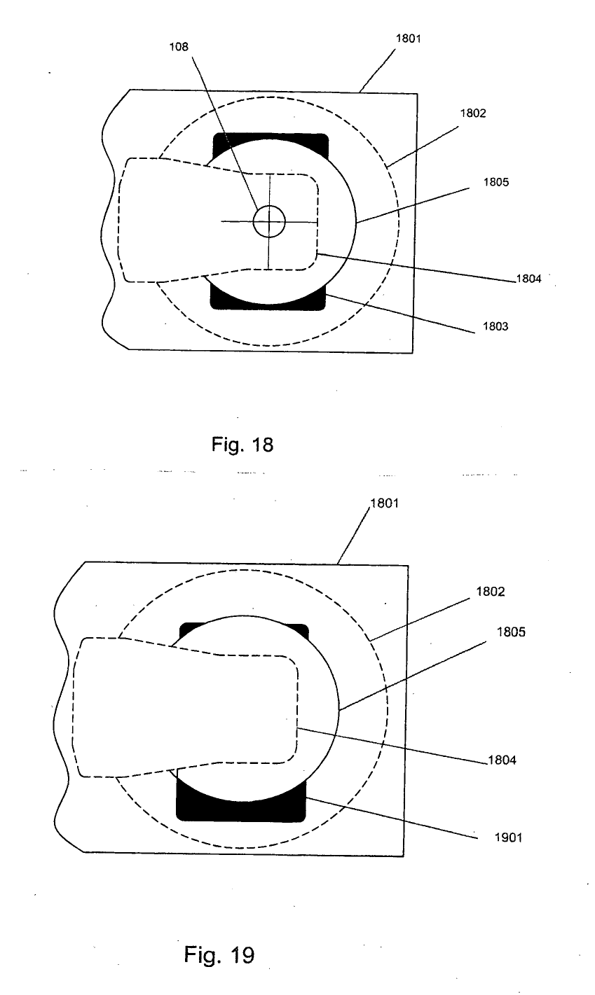

For a commercial available top load CDROM, CDR, DVD, etc. drive, the disk is dropped into to a sliding tray. The disc is then slides with the tray into the drive or out of a drive. FIG. 18 shows a top view of such sliding tray 1801 arrangement. A disc seat 1802 is usually provided to receive an optical disk having a diameter of 120 mm. Another smaller seat 1805 is provided for receiving a disk having a diameter of 80 mm. When the tray 1801 is slid into the drive, the spindle motor 108 is at center of the circular disc placement seats 1802 and 1805, and a rectangular card placement seat 1803. The opening 1804 in the tray 1801 allows the spindle motor 108 and other mechanism to access the optical media. For the purpose of carrying out data access stored in a card 101 that has a clamping hole at the center of the rectangular card placement seat 1803 is employed to receive the card 101. The seat 1803 is only necessary for feeding the card to the drive since the card 101 must be properly positioned relative to the position of the spindle motor 108 once a card 101 is fed into an optical drive. A card can seat to any position of tray seat 1802 when the card is ejected out of the optical drive with the tray 1801. When the clamping hole of a card is not at the center of a card 101, the card seat 1901 must be offset relative to the tray 1801 that allows the clamping hole of a card 101 to be positioned to spindle motor 108. FIG. 19 shows a card with the clamping hole that is not at the center of a card 101, the card seat 1802 must be offset as 1901 relative to the tray 1801 that allows the clamping hole of a card 101 to be positioned to spindle motor 108.

FIGS. 18 and 19 disclose a method to modify a compact disc (CD) tray of the commercially available CD or DVD drive to receive and process a rectangular shape card as that disclosed in this invention. Regular drive can take a circular disc with a diameter of 120 mm and 80 mm. By providing a rectangular card placement seat as shown, a tray that is commonly used to receive and process a circular disc can now be employed to receive and process a rectangular shape card with the logic and firmware modified as necessary according the inventions to be covered by further Patent Applications. This invention thus discloses a method for receiving and processing a non-circular shape data storage card by providing a placement seat in a tray of an optical drive.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An optical drive for accessing data stored in an optical medium layer on a data card comprising:
a receiving tray supported on a chassis for pivoting on a cam member for disposing said data card in two different vertical positions in said optical drive for an insertion/rejection operation at a first vertical position and for accessing data at a second vertical position.

2. The optical drive of claim 1 wherein:
said receiving tray further includes a card placement seat for receiving and placing said data card having a rectangular shape.

3. The optical drive of claim 1 wherein:
said receiving tray further includes a disc placement seat for receiving and placing said data card having circular-disc shape.

4. The optical drive of claim 1 wherein:
said cam member further includes a post for driving said receiving tray along a horizontal direction for receiving said data card in for accessing data on said data card and for pushing said data card out after completing a data access operation.

5. The optical drive of claim 1 further comprising:
a spindle motor supported on said chassis for engaging and rotating said data card through an opening in said receiving tray.

6. The optical drive of claim 1 further comprising:
an optical pickup head supported on said chassis for accessing data on said data card through an opening in said receiving tray.

7. The optical drive of claim 1 further comprising:
an accessing motor supported on said chassis for horizontally moving said optical pickup head for accessing data in different tracks on said data card through an opening in said receiving tray.

8. The optical drive of claim 1 further comprising:
a roller fixture actuated by a spring for pulling said data card into said receiving tray and push said data card out from the optical drive.

9. The optical drive of claim 1 further comprising:
a card stop for stopping a rotation movement of said data card of a non-circular shape and for restoring said data card in an original insertion orientation whereby said data card is ready for ejecting out from said optical drive.

10. The optical drive of claim 1 further comprising:
a focus adapter attached to an optical pickup head for compensating a thickness difference of said data card to maintain focus on said optical medium layer.

11. The optical drive of claim 10 wherein:
said focus adapter comprising a fixed lens attached to said pickup head.

12. The optical drive of claim 10 wherein:
said focus adapter comprising a movable lens attached to said pickup head for flexibly applying or moving away said focus adapter to access data cards of different thicknesses.

13. An optical drive for accessing data stored in an optical medium layer on a data card comprising:
an optical drive sliding tray having a card placement seat for receiving and placing a data card therein for sliding into said optical drive for a data access function.

14. The optical drive of claim 13 wherein:
said optical drive sliding tray further includes an offset.

15. The optical drive of claim 13 further comprising:
a focus adapter of 0.4 mm thick for receiving said data card of 0.76 mm in a commercially available CD or DVD optical drive.

16. An optical drive for accessing data stored in an optical medium layer on a data card comprising:
a focus adapter attached to an optical pickup head for compensating a thickness difference of said data card to maintain focus on said optical medium layer.

17. The optical drive of claim 16 further comprising:
a receiving tray supported on a chassis for pivoting on a cam member for disposing said data card in two different vertical positions in said optical drive for an insertion/rejection operation at a first vertical position and for accessing data at a second vertical position.

18. The optical drive of claim 17 wherein:
said receiving tray further includes a card placement seat for receiving and placing said data card having a rectangular shape.

19. The optical drive of claim 17 wherein:
said receiving tray further includes a disc placement seat for receiving and placing said data card having circular-disc shape.

20. The optical drive of claim 17 wherein:
said cam member further includes a post for driving said receiving tray along a horizontal direction for receiving said data card in for accessing data on said data card and for pushing said data card out after completing a data access operation.

21. The optical drive of claim 17 further comprising:
a spindle motor supported on said chassis for engaging and rotating said data card through an opening in said receiving tray.

22. The optical drive of claim 17 wherein:
said receiving tray further includes an opening to allow said optical pickup head supported on said chassis to extend to said data card for accessing data stored in said data card.

23. The optical drive of claim 17 further comprising:
an accessing motor supported on said chassis for horizontally moving said optical pickup head for accessing data in different tracks on said data card through an opening in said receiving tray.

24. The optical drive of claim 17 further comprising:
a roller fixture actuated by a spring for pulling said data card into said receiving tray and push said data card out from the optical drive.

25. The optical drive of claim 17 further comprising:
a card stop for stopping a rotation movement of said data card of a non-circular shape and for restoring said data card in an original insertion orientation whereby said data card is ready for ejecting out from said optical drive.

26. The optical drive of claim 16 wherein:
said focus adapter comprising a fixed lens attached to said pickup head.

27. The optical drive of claim 16 wherein:
said focus adapter comprising a movable lens attached to said pickup head for flexibly applying or moving away said focus adapter to access data cards of different thicknesses.

28. A method for accessing data stored in an optical medium layer on a data card by employing an optical drive comprising:
providing on a drive sliding tray with a circular and noncircular shaped card placement seat for receiving and placing a data card of either a circular or a no circular shape into said card placement seat for sliding into said optical drive for a data access function.

29. The method of claim 28 further comprising:
including an offset in said optical drive sliding tray.

30. The method of claim 28 further comprising:
attaching a focus adapter of 0.4 mm thick to an optical pickup head in said optical drive for receiving said data card of 0.76 mm in a commercially available CD or DVD optical drive.

31. A method for accessing data stored in an optical medium layer on a data cad by employing an optical drive comprising:
attaching a focus adapter to an optical pickup head to enable said optical drive to access data store in a data card of different thickness.
